(19) United States
(12) Patent Application Publication
(10) Pub. No.: US 2023/0400846 A1
(43) Pub. Date: Dec. 14, 2023

(54) HYBRID REASONING BASED ON PHYSICS AND MACHINE LEARNING FOR PROGNOSTICS OF SYSTEMS WITH CONFLATED DEGRADATION MODES

(71) Applicant: Novity Inc., San Carlos, CA (US)

(72) Inventors: Amirhassan Abbasi, Philadelphia, PA (US); Kai Frank Goebel, Mountain View, CA (US); Ion Matei, Mountain View, CA (US); Gaurang R. Gavai, San Francisco, CA (US)

(73) Assignee: Novity, Inc., San Carlos, CA (US)

(21) Appl. No.: 17/839,696

(22) Filed: Jun. 14, 2022

(51) Int. Cl. G05B 23/02; G06K 9/62

(52) U.S. Cl. CPC G05B 23/0283; G06K 9/6256

(57) ABSTRACT

A system and method for performing hybrid reasoning to predict remaining useful life of a target system. During operation, the system measures, via a set of sensors associated with the target system, sensor signals before a prediction start time. The system updates, based on the measured sensor signals, a first set of parameters of a physics-based model associated with the target system. The system in response to determining that the target system current time is less than a prediction start time: apply a machine-learning model to estimate a second aspect of the health of the target system; and update a second set of parameters of the physics-based model. The system can perform a time simulation of the updated physics-based model to predict a wear/degradation pattern of the target system after the prediction start time; and determine, based on the predicted wear/degradation pattern, a remaining useful life of the target system.

### RELATED APPLICATIONS

This application is related to U.S. patent Ser. No. 10/977,110 (Attorney Docket No. PARC-20170250US01, entitled “System and Method for Facilitating Prediction Data for Device Based on Synthetic Data with Uncertainties,” by inventors Ion Matei, Rajinderjeet S. Minhas, Johan de Kleer, and Anurag Ganguli, filed 27 Dec. 2017, the subject matter of which are herein incorporated by reference in their entirety.

### BACKGROUND

### Field

This disclosure is generally related to prognosis of health of a system under operation that has a generic wear or degradation pattern as time passes. More specifically, this disclosure is related to a system and method for performing hybrid reasoning based on physics and machine learning for prognostics.

### SUMMARY

The embodiments described herein provide a system and method for performing hybrid reasoning based on physics and machine learning for prognostics. During operation, the system can measure, via a set of sensors associated with the target system, sensor signals corresponding to a first loading cycle of the target system before a prediction start time. The system can update, based on the measured sensor signals, a first set of parameters of a physics-based model associated with the target system. The first set of parameters can represent a first aspect of health of the target system. The system can in response to determining that the target system is subject to a next cycle of loading and the current time is less than a prediction start time: apply a machine-learning model to estimate a second aspect of the health of the target system; and update, based on the estimated second aspect of the health of the target system, a second set of parameters of the physics-based model. The system can then perform a time simulation of the updated physics-based model to predict a wear/degradation pattern of the target system corresponding to after the prediction start time; and determine, based on the predicted wear/degradation pattern, a remaining useful life of the target system.

In a variation of this embodiment, the first aspect of the health of the target system represents a first mode of degradation on a first timescale. The second aspect of the health of the target system represents a second mode of degradation on a second timescale. The first timescale is different from the second time scale and degradation includes one or more additional degradation modes.

In a variation on this embodiment, the prediction starts after an initial period of operation of the target system.

In a further variation on this embodiment, an intersection of the predicted wear/degradation pattern and an end-of-life threshold represents a predicted end-of-life of the target system. The remaining useful life of the target system corresponds to the difference between a current time of the target system and the predicted end-of-life of the target system.

In a further variation on this embodiment, the system can train the machine learning model with data from a training system to generate a set of machine learning model parameters, wherein the training system includes one or more systems with respective wear/degradation pattern similar to wear/degradation pattern of the target system; incrementally update, based on the measured sensor signals, the set of machine learning model parameters; and incrementally estimate, based on the updated set of machine learning model parameters, the second aspect of the health of the target system.

In a variation on this embodiment, the target system can correspond to a system subject to degradation and/or wear with time, wherein the target system includes one or more of: a battery; power storage devices; rotating machines; chemical plants; automotive components; biomedical components; aerospace components; nuclear power components; maritime components; mining components; medical equipment components; manufacturing systems components; civil engineering related systems; and electrical engineering related systems.

In a further variation on this embodiment, the system can apply a set of signal processing techniques to measured sensor signals to obtain a set of features for developing the machine learning model and updating the physics-based model.

In a further variation on this embodiment, the signal processing techniques include one or more of: data scrubbing; feature extraction; and data transformation.

In a further variation on this embodiment, the system can in response to determining that the target system is subject to the first loading cycle, calibrate, based on the measured sensor signals, the parameters of a physics-based model associated with the target system.

In a further variation on this embodiment, the system can update, based on the measured sensor signals, the first set of parameters of a physics-based model associated with the target system by: performing error minimization between output of the time simulation of the physics-based model and measured sensor signals during the next loading cycle of the target system; obtaining, based on the error minimization, a new first set of parameters; and updating, based on the new first set of parameters, the physics-based model.

### BRIEF DESCRIPTION OF THE FIGURES

FIG. 1 shows a generic wear/degradation pattern for a target system under constant load condition, in accordance with an embodiment of the present application.

FIG. 2 illustrates an exemplary hybrid reasoning system architecture, in accordance with an embodiment of the present application.

FIG. 3 illustrates different data pre-processing techniques, in accordance with an embodiment of the present application.

FIG. 4 illustrates exemplary high-level components for developing a hybrid model, in accordance with an embodiment of the present application.

FIG. 5A shows an exemplary hybrid prognosis reasoning for predicting a wear/degradation pattern and remaining useful time of a target system, in accordance with an embodiment of the present application.

FIG. 5B shows an exemplary hybrid prognosis reasoning for predicting voltage discharge trajectory and end of discharge time for a lithium-ion battery, in accordance with an embodiment of the present application.

FIG. 6A presents an exemplary physics-based model prognosis reasoning, in accordance with an embodiment of the present application.

FIG. 6B illustrates an algorithm for determining a numerical solution of a state space representation of a physics-based model, in accordance with an embodiment of the present application.

FIG. 6C illustrates the Levenberg-Marquardt algorithm for solving a minimization problem, in accordance with an embodiment of the present application.

FIG. 6D presents an exemplary machine learning model to estimate a second aspect of health of a target system, in accordance with an embodiment of the present application.

FIG. 7A illustrates an exemplary hybrid reasoning system architecture with mutual coupling between physics-based model and machine learning model, in accordance with one embodiment of the present application.

FIG. 7B shows an exemplary end of discharge time prediction for a hybrid reasoning system, in accordance with an embodiment of the present application.

FIG. 8 illustrates an exemplary hybrid reasoning system architecture with mutual coupling between physics-based model and machine learning model with incremental learning, in accordance with one embodiment of the present application.

FIG. 9 shows an exemplary end of discharge time prediction for a hybrid reasoning system with incremental learning, in accordance with an embodiment of the present application.

FIGS. 10A-10C present a flowchart illustrating a process for performing hybrid reasoning based on physics and machine learning for prognostics, in accordance with one embodiment of the present application.

FIG. 11 illustrates an exemplary computer system that facilitates hybrid reasoning based on physics and machine learning for prognostics, in accordance with one embodiment of the present application.

In the figures, like reference numerals refer to the same figure elements.

### DETAILED DESCRIPTION

The following description is presented to enable any person skilled in the art to make and use the embodiments and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown but is to be accorded the widest scope consistent with the principles and features disclosed herein.

### Overview

Rapid advances in a broad range of engineering fields, e.g., aerospace, agriculture, automotive, biomedical, civil, and electrical engineering, have increased demands for prognostics and health management strategies. Such strategies can reduce downtime, operational cost, and improve productivity, reliability, maintainability, and safety of the system under consideration.

The overall design of the prognostics and health management strategies involves elements of monitoring of equipment through sensors, and analysis of the sensor measurements to arrive at system health assessment and prediction of remaining equipment life. Depending on application domain, operator requirements, physical and practical limitations, and priorities, such design considerations can result in different specifications for different domains of applications. Since the target systems, i.e., the system for which system health managements strategies are being designed, may share some generic and high-level similarities, one can take advantage of these similarities. For example, a broad range of assets from tools in subtraction manufacturing like drilling machines, milling machines inserts and lathe to bearings in rotating equipment or even lithium-ion batteries in power storage devices follow a typical degradation/wear pattern. A target system that follows such a time dependent and load dependent wear/degradation pattern will progress towards the end of life. It should be recognized that any system may have different degradation modes that are active at any given time. Often, these different degradation modes manifest themselves with different symptoms (although there may be considerable overlap) and they may act on different time scales. In other words, one degradation mode may advance slowly while another mode may advance considerably fast. Irrespective of that, prognostics and health management strategies based on the generic characteristics of this degradation/wear pattern can provide for transferability and adaptability of the knowledge and therefore result in lower cost of deployment. However, given the complexity, nonlinearity, and multi-physical nature of the target system, e.g., lithium-ion batteries, accurately predicting the end of discharge time is non-trivial.

Some of the embodiments described in the present application solve the technical problem of predicting the remaining useful life of engineered systems, subsystems, assets, and components by predicting a generic wear/degradation pattern based on a hybridized physics-based model and machine learning model. Specifically, a hybrid reasoning system is provided that leverages the strengths of both the data-driven and physics-based modeling while avoiding some of the shortcomings. Furthermore, the hybrid reasoning system can be generalized to domains different from the lithium-ion batteries which have a similar wear/degradation pattern. In addition, the hybrid reasoning system can overcome the challenges associated with both training data scarcity and incomplete knowledge of faults and their progression in physics-based modeling. The hybrid reasoning system can provide an accurate, early, fast, robust, cost-efficient, interpretable, and explainable prognostics by prediction and analysis of the wear/degradation pattern.

As an example, use-case, lithium-ion batteries discharge prognostics is taken into consideration, however the hybrid reasoning system can be applied to other domains of application or use cases which follow a similar wear/degradation pattern. For example, other domains of application can include and is not limited to rotating machines (e.g., turbines, pumps, compressors, etc.), power storage devices, chemical plants, aerospace components, nuclear power components, maritime components, mining components, medical equipment components, manufacturing systems components, automotive components, biomedical components, civil engineering related systems, electrical engineering related systems, etc.

### Wear/Degradation Pattern

In existing systems design of prognostics and health management systems is based on the requirements, limitations, and priorities of a particular user and the application domain. Such design considerations can result in different specifications for different systems which can limit the adaptability and transferability of the same design to other domains of applications.

It is therefore useful to identify these differences and similarities shared among the different assets. For example, a broad range of assets subject to uniform load conditions may follow a typical time-dependent wear/degradation pattern. In other words, during the operation of the target system, the target systems' health condition may follow a similar time-dependent degradation pattern and will progress towards the end of life in a similar way. For systems with varying loads, the wear evolution is also similar but may have to include the impact of varying load.

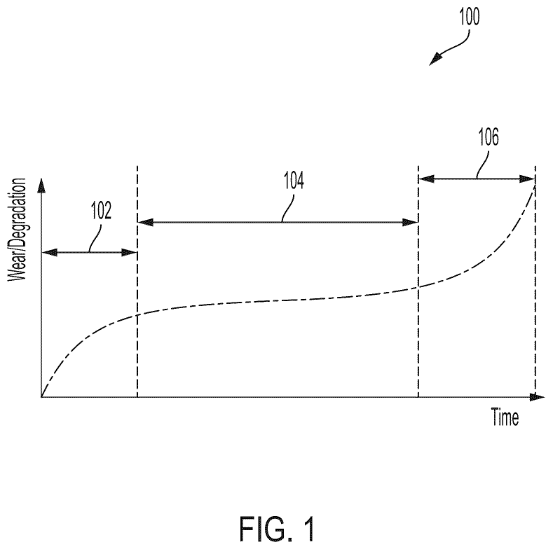

Developing prognostics and health management strategies based on the generic characteristics of this degradation/wear pattern can facilitate adaptability and transferability between different assets. FIG. 1 shows a generic wear/degradation pattern for a target system under constant load condition, in accordance with an embodiment of the present application. In the example shown in FIG. 1, the wear/degradation pattern 100 can be characterized into three phases which can include a rapid initial drop (an initial wear period) 102, a slow quasi-linear wear/degradation progression 104, and a sharp exponential drop 106 or an accelerated wear/degradation toward an end-of-life of the target system under consideration. The generic wear/degradation pattern 100 depicted in FIG. 1 can be observed in a wide range of assets, e.g., in voltage discharge of lithium-ion batteries, in subtracting manufacturing like drilling machines, milling machines inserts, lath, and bearings in rotating equipment. All these assets may exhibit typical pattern 100 depicted in FIG. 1.

In one embodiment, a hybrid reasoning system can analyze and predict wear/degradation pattern 100 to provide a generic framework that can be easily adapted to different assets with minor modification or tuning. Further, pattern 100 can provide a generic framework that can provide an accurate, early, fast, robust, cost-efficient, interpretable, and explainable prognostics.

For example, predicting an accurate end of discharge can be of significance in power storage devices with lithium-ion batteries since the prediction can determine the amount of time that batteries can provide power with an acceptable magnitude. Using only a data-based approach or only a physics-based approach to predict wear/degradation pattern or mechanism 100 can be difficult. This is because the amount of available data can be insufficient and non-representative of the target system, for example because run-to-failure observation may not have been recorded in sufficient number because the failure does not happen very often. Furthermore, the physics-based models can be incomplete, e.g., the knowledge about the physics of faults and their progression can be incomplete, and the physics-based models can be complex which means that considerable effort would have to be undertaken to encapsulate the underlying physics into a mathematical model where the magnitude of the effort does not justify the benefit of end-of-life prediction.

Some of the embodiments described in this application can predict wear/degradation pattern 100 and the corresponding remaining useful life of the target system by optimally integrating physics-based model and machine learning model where the physics-based model may only capture fairly rudimentary phenomena and where the machine learning model is tuned to work with few run-to-failure datasets. Such an integration of the physics-based model and the machine learning models can result in a hybrid reasoning framework that leverages the strengths of both data-driven and physics-based modeling while avoiding some of the shortcomings

One embodiment described in the present application can provide a system and method to generalize the hybrid reasoning framework to systems different from the lithium-ion batteries, with similar degradation/wear pattern. In addition, the system can overcome challenges of both training data scarcity and incomplete knowledge of physics-based modeling. Wear/degradation pattern 100 is not limited to lithium-ion batteries but can also be observed in other systems or assets.

In another embodiment described in the present application, the wear/degradation pattern observed over several loading cycles can be characterized by a first mode of degradation and a second mode of degradation. The first mode of degradation propagates on a relatively fast time scale, and can be modeled by physics, while the second mode of degradation that propagates on a slower time scale (when compared to the first mode of degradation) can be modeled by machine learning. Also, degradation may include additional modes as well which can be modeled either by physics or machine learning given the availability of data or feasibility of physics-based model. Therefore, a system implementing hybrid reasoning can take into account different degradation modes that may propagate in different time scales to predict a generic wear/degradation pattern. Therefore, the system can leverage the physics-based model and machine learning model to provide a hybrid prognostics method that is interpretable, explainable, fast, accurate, online, data-efficient, and robust. Furthermore, considering a generic wear/degradation pattern can enhance the hybrid reasoning system's adaptability and transferability. For example, the system can generalize the reasoning used for lithium-ion batteries to different systems with similar wear/degradation pattern.

### System Architecture for Hybrid Reasoning

As already explained, some of the embodiments described in this application can solve the technical problem of predicting remaining useful life of engineered systems, subsystems, assets, and components by predicting a generic wear/degradation pattern based on a hybridized physics and machine learning reasoning.

Generally, physics-based prognostics reasoning attempts to abstract the wear/degradation progression in a mathematical framework. Consistency with physical laws and mechanistic mathematical abstraction of underlying causalities provide for accurate, robust, interpretable, and explainable reasoning. However, typically physics of wear/degradation progression, faults, and failure is nonlinear, multi-scale, complex and only partially known. Hence, incomplete knowledge about the underlying physics can result in simplifications, assumptions, and high-level abstractions. Consequently, accuracy of the reasoning can be adversely affected by deviating from real conditions to simplified and abstracted ones.

On the other hand, an increased desire to monitor industrial equipment as well as numerous advances in sensory technologies and computational hardware have resulted in widely accepted practice of collecting operational data. Hence, predictive models can in principle be developed purely based on data and independent of knowledge of the underlying wear/fault progression and failure. However, some events of interest do not happen very frequently. It is common that a system may go for years, even decades without failure. This results in an insufficient number of historical run-to-failure data, and therefore lacking ability to use evolving fault patterns for training of data-driven systems.

One embodiment described in the present application solves these problems by providing a hybrid prognostic methodology that leverages generic, robust, and interpretable representation of physics with machine learning ability in developing complex mapping using data. Thus, hybrid reasoning provides for an optimized coupling between physics-based model and machine learning model to predict a remaining useful life of a target system.

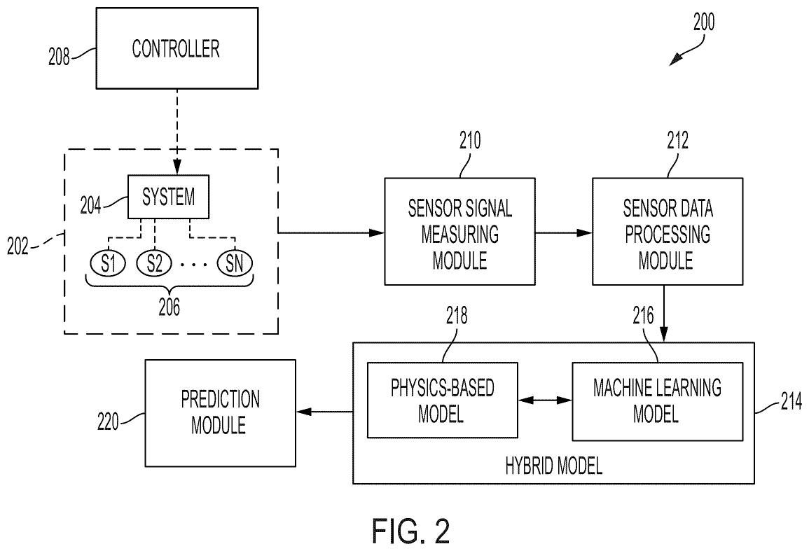

FIG. 2 illustrates an exemplary hybrid reasoning system architecture, in accordance with an embodiment of the present application. In the example shown in FIG. 2, system architecture 200 can include a target system 204 (or subsystems, assets, and components) with multiple sensors 206 attached. Sensors 206 can measure one or more attributes of target system 204. For example, the sensors can be associated with a wide range of measurement components which can include and are not limited to temperature, acceleration, strain, force, pressure, current, displacement, vibration, force, etc. Sensors 206 can be deployed in places where the probability of extracting information associated with the potential fault is high.

For example, with the deployment of sensors 206 in certain relevant locations, system 200 may gain information in sensor signals or raw data that provide an indication about the health of target system 204. In other words, system 200 may extract certain features from the sensor signals that are informative about health condition, faults, and their progression in the target system. The system may also combine information from different sensor readings which can be directly or indirectly related to the health of target system 204.

Monitored system 202 can represent target system 204 monitored via a set of sensors 206. For example, to identify a certain type of abnormality, fault, outage, or failure caused by an equipment malfunction, system 200 may measure and monitor sensor readings that provide information about the equipment or target system 204. Sensors 206 may capture information about nominal operation of target system 204, a change from nominal operation to abnormal operation, and then a change to a state where target system 204 is no longer working according to a functional specification or performance metric, e.g., unable to produce a part that satisfies a certain quality criterion. Target system 204 can exhibit a wear/degradation pattern (pattern 100 shown in FIG. 1) as time passes and loading is continued. Controller 208 can determine a loading profile applied to target system 204 over a time range that can be defined by a user of system 204. Specifically, controller 208 can determine a time rate of the target system's usage. For lithium-ion battery, loading can represent a charge-discharge cycle.

System architecture 200 can further include a sensor signal measuring module 210 for measuring and recording the sensor signals from set of sensors 206. Sensor signal measuring module 210 can perform data acquisition for collecting monitored sensor signals. In other words, sensor signal measuring module 210 can measure with sensors 206 and record measurement updates based on observations from target system 204 which can be used for estimating a state of target system 204 and for performing prognosis. Module 210 can design data acquisition based on practical constraints of target system 204 such as weight, sensitivity, power demands, volume, and cost of sensor deployment for target system 204 in different domains of application and industries, e.g., aerospace, automotive, electronics, chemicals, energy, marine, etc.

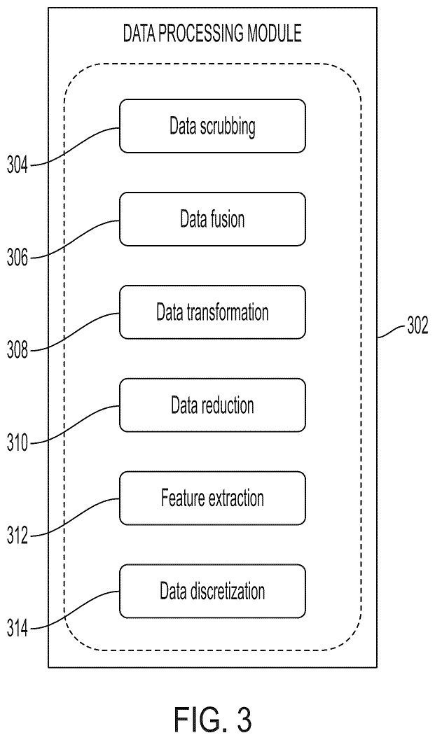

Sensor data processing module 212 can perform different data processing operations on the sensor signals and provide the processed data to a hybrid model 214. The different data processing operations are described below with reference to FIG. 3.

Hybrid model 214 can optimally hybridize a machine-learning model 216 and a physics-based model 218 to perform a hybrid reasoning about the health of target system 204. The hybridized model can operate on the pre-processed data from sensor data processing module 212. Based on the output of hybrid model 214, prediction module 220 can perform prognostics and predict a remaining useful life of target system 204. The remaining useful life (RUL) can be defined as an estimate of the amount of time target system 204 will serve its expected task. During this estimated time, performance metrics of target system 204 will be better than those at end-of-life threshold. In an engineering sense, RUL can be interpreted as an estimation of the amount of time before a system is to be repaired or replaced.

In one use-case example, target system 204 can be a lithium-ion battery, and system 200 can apply hybrid reasoning to predict an end of discharge time. During the operation of the lithium-ion battery, as time progresses the voltage discharge progression is allowed to approximately to a cutoff voltage of 2.8 V. According to the battery data which were obtained from the prognostics data repository at NASA Ames, the batteries were charged up to about 4.2 V by an initial constant current profile of 1.5 A until 4.2 V is reached. It is followed by a constant voltage mode until the charge current drops to 10 mA. For discharge experiments, constant electric current load of 2 A was used. At fully discharged condition (100% depth of discharge) batteries reached 2.8 V. Sensor signal measuring module 210 can measure and record sensor signals that can be represented as cycle measurements of terminal current, voltage, cell temperature, and cycle to cycle measurements of capacity. Sensor data processing module 212 can perform data scrubbing and feature extraction operations. System 200 can store the pre-processed data in a machine readable and compact format for further computational operations. Hybrid model 214 can apply a hybridized physics and machine learning model to predict the voltage discharge trajectory based on hybrid reasoning. Prediction module 220 can predict the discharge progression and end of discharge time based on the hybrid reasoning and predicted voltage discharge trajectory.

FIG. 3 illustrates different data pre-processing techniques, in accordance with an embodiment of the present application. In the example shown in FIG. 3, data processing module 302 (shown as sensor data processing module 212 in FIG. 2) can perform different data processing operations. For example, data scrubbing 304 can fill in missing data, remove outliers, and smoothen the noisy data. Data processing module 302 can perform data fusion 306 to compile data received from different sources to increase the probability of information condensation. Data transformation 308 operation can normalize and aggregate the assembled data. Data reduction 310 operation can decrease the size of data to reduce computational complexity and reduce the computational resource usage. Feature extraction 312 operation can extract certain features associated with the sensor signal that are correlated and can provide information about a mapping algorithm's target. Data discretization 314 operation can transfer continuous data to a discrete space, in which data can be represented by a finite set of numbers. Based on specific characteristics of each domain of application and observed data, a certain set of data operations from 304-314 can be selected and applied.

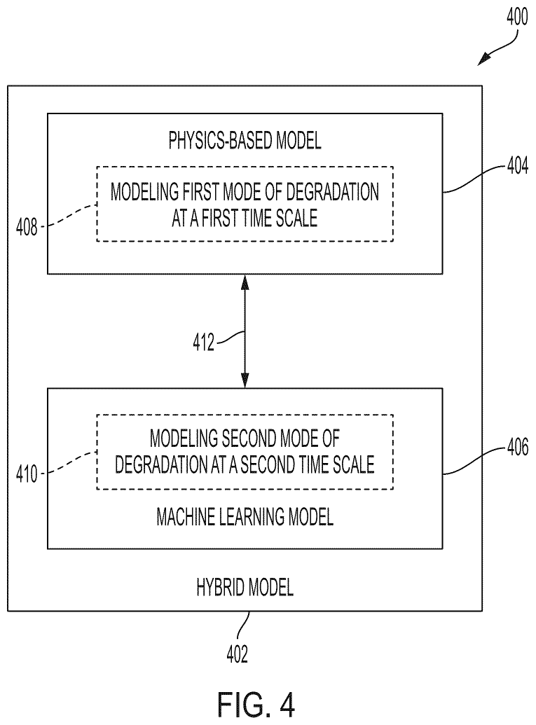

FIG. 4 illustrates exemplary high-level components for developing a hybrid model, in accordance with an embodiment of the present application. In the example shown in FIG. 4, block diagram 400 shows a hybrid model 402 with a physics-based reasoning or model 404 to govern the first mode of wear/degradation process. In other words, physics-based model 404 can model the first mode of degradation on a first timescale 408. Hybrid model 402 can further include a machine learning reasoning or model 406 for modeling a second mode of degradation at a second time scale 410. The second mode of degradation, e.g., degradation due to a reduction in capacity (aging) or overall performance capability of the target system, occurs over sequential loading cycles which can have a relatively larger time scale compared to the first timescale associated with the first mode of degradation.

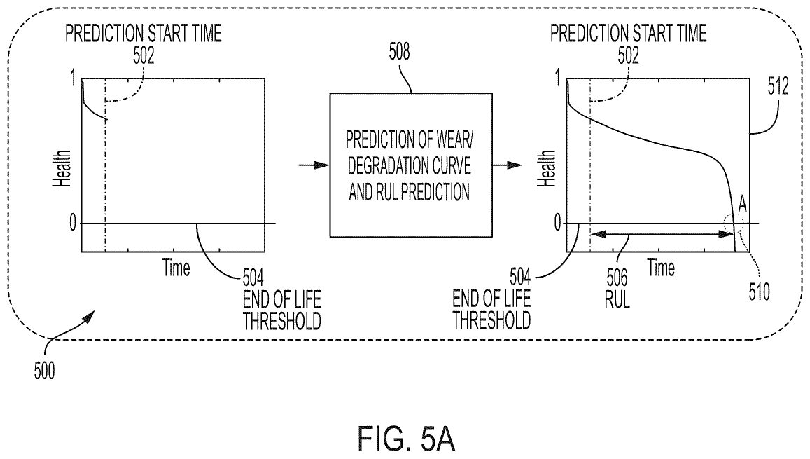

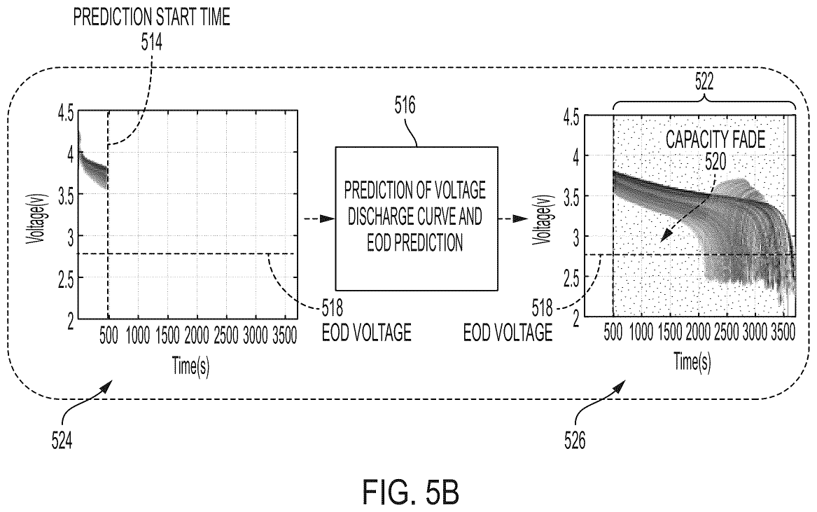

The system can categorize the wear/degradation based on propagating time scale for complex engineering systems, e.g., gas turbines, chemical plants, and power storage systems. A slow degradation progression can be observed with respect to the entire system while a fast degradation progression can be observed at system's component levels. For example, in a lithium-ion battery, the first mode of wear/degradation can represent the voltage discharge that indicates the amount of time duration that the battery can keep voltage over a particular threshold, e.g., a discharge threshold voltage of 2.8 V. The second mode of degradation can represent aging of the lithium-ion battery which can be related to the capacity fade over consecutive charge and discharge cycles. The first mode and the second mode of wear/degradations can be conflated and mutually connected 412, and such a connection is described below with reference to FIGS. 5-8.

FIG. 5A shows an exemplary hybrid prognosis reasoning for predicting a wear/degradation pattern and remaining useful time of a target system, in accordance with an embodiment of the present application. The example shown in FIG. 5A, illustrates how a hybrid reasoning system can apply hybrid reasoning to predict wear/degradation pattern. Plot 500 shows sensor data recorded up to prediction start time 502. An operation of predicting wear/degradation pattern and RUL (operation 508) can be applied to recorded sensor data up to prediction start time 502 to predict a health indicator. At threshold 502 the hybrid reasoning system can predict the wear/degradation pattern (shown in plot 512). The hybrid reasoning system can identify an intersection 510 (point A in plot 512) of the predicted trajectory in plot 512 with an end-of-life threshold 504 and use intersection 510 for predicting end-of-life time and corresponding RUL 506.

FIG. 5B shows an exemplary hybrid prognosis reasoning for predicting voltage discharge trajectory and the end of discharge time for a lithium-ion battery, in accordance with an embodiment of the present application. For lithium-ion batteries, the wear/degradation pattern is equivalent to discharge of voltage. Prediction start time 514 is given by t=tₚ. In one example, prediction start time 514 for lithium-ion batteries can be 500 seconds(s). However, prediction start time 514 may vary depending upon the type of target system under consideration and prediction can be continued over time.

The hybrid reasoning system may use the sensor data available up to prediction start time 514 to predict discharge progression (operation 516). In FIG. 5B the discharge progression is indicated by region 522 of plot 526. The hybrid reasoning system may identify an intersection of each predicted trajectory with end of discharge (EOD) threshold voltage 518, e.g., the EOD threshold can be 2.8 V. Based on this identified intersection, the hybrid reasoning system may determine a predicted end of discharge time for the lithium-ion battery.

In plots 524 and 526 of FIG. 5B, the y-axis shows the discharge voltage and the x-axis denotes discharge time. Plot 526 depicts the voltage discharge trajectories with each trajectory corresponding to one cycle of loading and plot 526 also indicates a capacity fade 520 that happens over a relatively large time scale. Each trajectory shows a slow quasi-linear region followed by an accelerated exponential decay.

### Physics-Based Model for a First Mode of Degradation

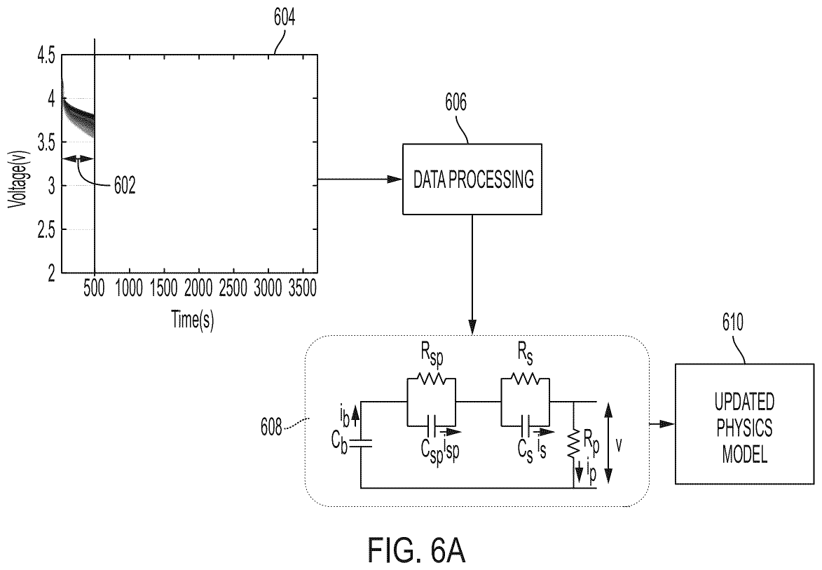

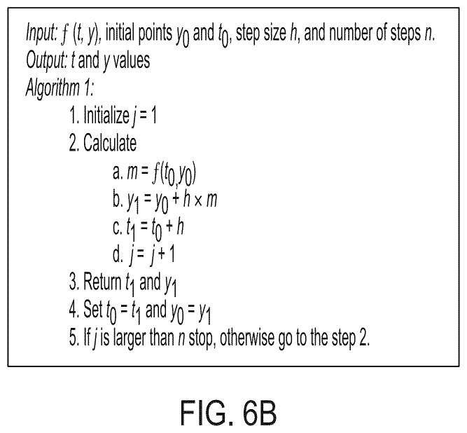

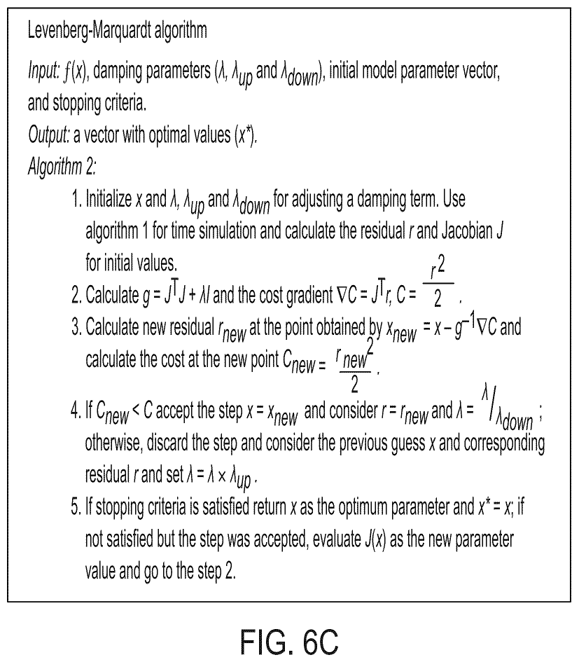

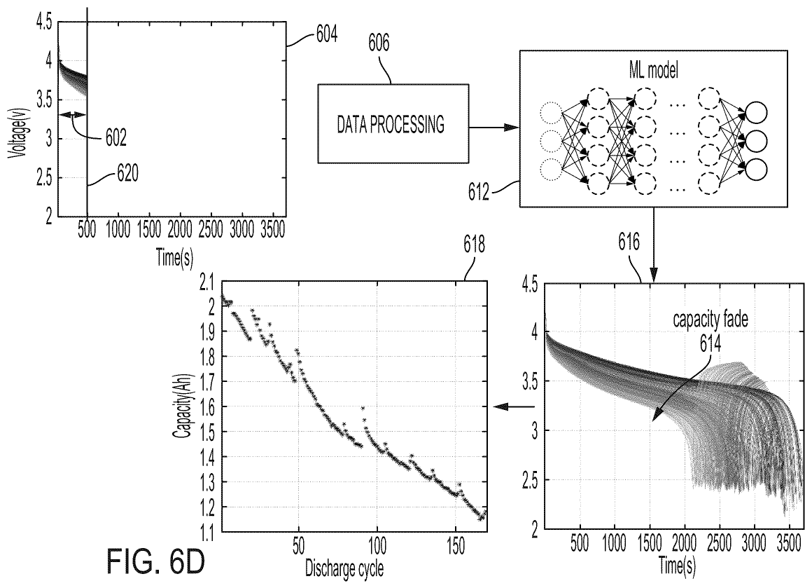

FIG. 6A presents an exemplary physics-based model prognosis reasoning, in accordance with an embodiment of the present application. In the example shown in FIG. 6A, details of using physics for abstraction of the first mode of wear/degradation is illustrated. In FIG. 6A, an empirical model 608 is used that parametrizes the wear/degradation pattern using each run to failure trajectory. Empirical model 608 can represent the wear/degradation in a mathematical framework in which the inputs are sensor data (from data processing operation 606) and the output is an updated physics model 610 that can be used for time simulation and obtaining a health indicator value. The system can perform data processing operations 606 on sensor signals observed during an initial time period 602.

In order to provide a balance between complexity and accuracy, the system can apply an electrical circuit model (ECM) 608 as a special family of empirical models. ECM can include equivalent electrical components and empirical equations. The system may identify ECM 608 parameters value based on the measured data from observations. ECM 608 may correspond to a lithium-ion battery.

In the example ECM 608 for a lithium-ion battery, a large capacitance C_{b} may keep charge q b of the lithium-ion battery. The non-linear C_{b} can capture the open circuit potential and concentration overpotential. The Rₛₚ−Cₛₚ pair can represent a non-linear voltage drop given the surface overpotential, Rₛ can capture the ohmic drop, and Rₚ stands for the parasitic resistance representing self-discharge.

For ECM 608, a state of the charge (SOC) can be denoted as:

$$S O C = 1 - \frac{{q}_{max} - {q}_{b}}{{c}_{max}} \qquad ( 1 )$$

where q_{b} indicates the current charge in the battery, qₘₐₓ is the maximum possible charge or discharge capacity, and Cₘₐₓ is the maximum possible capacity. The surface overpotential can be denoted as a function of SOC:

Rₛₚ=Rₛₚ_{₀}+Rₛₚ_{₁} exp(Rₛₚ_{₂}(1−SOC)) (2)

where Rₛₚ_{₀}, Rₛₚ_{₁} and Rₛₚ_{₂} are empirical parameters.

Voltage drop across the individual circuit components can be given by:

$${V}_{b} = \frac{{q}_{b}}{{C}_{b}} \qquad ( 3 )$$

$${V}_{s p} = \frac{{q}_{s p}}{{C}_{s p}} \qquad ( 4 )$$

$${V}_{s} = \frac{{q}_{s}}{{C}_{s}} \qquad ( 5 )$$

$${V}_{p} = {V}_{b} - {V}_{s p} - {V}_{s} \qquad ( 6 )$$

where qₛₚ represents the charge corresponding to capacitance Cₛₚ, qₛ is the charge associated with Cₛ, and V_{b} corresponds to the open-circuit voltage. C_{b} can be written as a function of SOC, i.e., C_{b}=C_{b0}+C_{b1}SOC+C_{b2}SOC²+C_{b3}SOC³. The voltage, V, of the battery is given by V=V_{b}−Vₛₚ−Vₛ. Current associated with each element and their corresponding charges are summarized in Table 1 below.

TABLE 1
Current and charge associated with each element in ECM 608

| Current | Charge |
|---|---|
| ${i}_{b} = {i}_{p} + i ; {i}_{p} = \frac{{V}_{p}}{{R}_{p}}$ | \dot{q}_{b} = −i_{b} |
| ${i}_{s p} = {i}_{b} - \frac{{V}_{s p}}{{R}_{s p}}$ | \dot{q}_{sb} = iₛₚ |
| ${i}_{s} = {i}_{b} - \frac{{V}_{s}}{{R}_{s}}$ | \dot{q}ₛ = iₛ |

Given the above set of equations, the parameters of ECM 608 can be denoted in a set as

Mₚ={C_{b0},C_{b1},C_{b2},C_{b3},Rₛ,Cₛ,Rₚ,Cₛₚ,Rₛₚ₀,Rₛₚ₁,Rₛₚ₂,qₘₐₓ,Cₘₐₓ}

The physics-based modeling system may obtain ECM 608 parameters by minimizing the deviation between the simulation data and observed data. The minimization can be defined as:

min f(x)=Σᵢ₌₁^{m}(Vₘ(tᵢ)−Vₛ(x,tᵢ))² (7)

where x∈R and t∈[tₛ t_{f}]. Also, x denotes the model parameters' vector and f(x) represents the sum of square of deviations in m data points between simulated voltage data Vₛ(x,t) and the measured voltage data Vₘ(t). Time t changes in a range with lower band tₛ and upper band t_{f}, where tₛ and t_{f} show the start and end time of minimization in each loading cycle, respectively.

The system modeling the physics-based model may calculate the simulated voltage discharge (Vₛ(t)) by transferring the charge related equations in Table 1 to a state space with states y=[q_{b},q_{sb},qₛ] and solving an algorithm shown in FIG. 6B with a state update function of f(t,y).

FIG. 6B illustrates an algorithm for determining a numerical solution of a state space representation of a physics-based model, in accordance with an embodiment of the present application. The system modeling the physics-based model may apply algorithm shown in FIG. 6B to determine a numerical solution for state space representation of physics-based model equations (i.e., first order ordinary differential equations) and to calculate a simulated discharge voltage of the battery (Vₛ(t)).

Further, to solve the minimization problem, equation (7) can be written as:

Σᵢ₌₁^{m}(Vₘ(tᵢ)−Vₛ(x,tᵢ))²=Σᵢ₌₁^{m}Fᵢ²(x) (8)

The term F(x) can be denoted as,

$$F ( x ) = ⌈ \begin{matrix}\begin{matrix}\begin{matrix}{V}_{s} ( {t}_{1} ) - {V}_{m} ( x , {t}_{1} ) \\ {V}_{s} ( {t}_{2} ) - {V}_{m} ( x , {t}_{2} )\end{matrix} \\ ⋮\end{matrix} \\ {V}_{s} ( {t}_{m} ) - {V}_{m} ( x , {t}_{m} )\end{matrix} ⌉ \qquad ( 9 )$$

Jacobian matrix of F(x) is denoted by J(x) and gradient of f(x) is G(x). The minimization problem is solved by Levenberg-Marquardt algorithm (LMA). This method for finding optimal values of the parameter vector x shown by x* uses a search direction that is given by solution δ to the following equation,

(J^{T}J+λI)δ=J^{T}r (10)

with λ a non-negative damping parameter, I is an identity matrix, and r denotes a residual vector. FIG. 6C illustrates the Levenberg-Marquardt algorithm for solving a minimization problem, in accordance with an embodiment of the present application. The system may apply the LMA shown in FIG. 6C to solve the minimization problem in an iterative process starting from a set of initial values.

In each cycle of loading, during the minimization process, the system may obtain the optimal values for model parameters in Mₚ that makes the physics-based model's time simulation outputs fitted on corresponding cycle's measured voltage discharge data (Vₛ(x,tᵢ)).

### Machine Learning Model for a Second Mode of Degradation

FIG. 6D presents an exemplary machine learning model to estimate a second aspect of health of the target system, in accordance with an embodiment of the present application. The example shown in FIG. 6D demonstrates a machine learning model 612 that can provide a mapping between an input and an output. Input can be sensor signal information or voltage time change for a lithium-ion battery during an initial time period 602 or up to a prediction start time 620 (shown in plot 604). The system may perform data processing operations 606 on the sensor signals. Output of machine learning mode 612 can represent a health indicator corresponding to the second mode of degradation that is capacity fade 614 (aging) for a lithium-ion battery (shown in plot 616). In other words, at prediction start time 620, the machine learning model 612 can estimate discharge capacity (shown in plot 618). The system implementing machine learning model 612 estimate the discharge capacity (plot 618) that represents the second mode of degradation for a lithium-ion battery. In FIG. 6D, a prediction start time of 500 s is selected as a point at which the system estimates the discharge capacity. Selection of machine learning model 612, development, and deployment can be dependent on specifications corresponding to a type of application.

Given the non-linearity of the mapping between the input and output of the machine learning model, an artificial neural network in the form of a multi-layer perceptron can represent the machine learning model. In one embodiment of the application, machine learning model 612 can be an artificial deep neural network in the form of multi-layer perceptron. The input for model 612 can be a set of features extracted (operation 606) from voltage data observed in the range 602 up to the prediction start time 620 and output of model 612 can be discharge capacity (qₘₐₓ). The input feature set can include kurtosis, skewness, first-derivative, second derivative, peak to root mean square ratio, root mean square, entropy, energy, and mean.

Model 612 which can be an artificial deep neural network that can include one input layer, two hidden layers, and one output layer. The hidden layers activation and output layer activation functions can be sigmoid and linear, respectively. Model 612 may set the initial values of weight and bias randomly and can update them according to Levenberg-Marquardt method. In one example implementation of model 612, the number of neurons in the hidden layer connected to the input layer can be thirty and the number of neurons connected to the output layer can be twenty, output layer can have a single neuron. In one embodiment, data can be randomly separated for training, validation, and testing, e.g., 60% of data for training, 15% of the data for validation, and 25% of the data for testing (other ratios of data separation are also possible). The number of neurons in the input layer is based on the number of input variables (here they are nine). The stopping criteria can be maximum validation failures (e.g., 10) and performance gradient can be, e.g., 1e−7. Mean square of difference between network prediction and measured values for discharge capacity values can be used as a measure of performance.

A system may train machine learning model 612 to estimate discharge capacity (qₘₐₓ) that represents the second mode of degradation (or ageing) which can occur due to the capacity fade over consecutive charge-discharge cycles and can be used in performing hybrid reasoning.

### Hybridizing Physics-Based Model and Machine Learning Model

Predicting EOD based on EC models can be sensitive to model parameters. As explained earlier two sets of physics-based model parameters were defined. The first set of parameters of a physics-based model is associated with the target system, wherein the first set of parameters represents a first aspect of health of the target system and the first mode of degradation. Also, a second set of parameters of the physics-based model is considered that represents the second aspect of the health of the target system and the second mode of degradation. In the example of lithium-ion batteries, the battery discharge capacity can be a main indicator of second mode of degradation which affects the time rate of charge depletion.

In other words, battery discharge capacity estimation can affect the part of the EC model parameters that represents the second mode of degradation (the second set of parameters). This second mode notably changes when the discharge threshold (the intersection points of predicted discharge trajectory and discharge threshold) is reached. The part of the EC model that is updated by battery discharge capacity estimation is critically important in accurate end-of-discharge prognosis. Parameters that are categorized in the first set of model parameters can be estimated in the quasi-linear phase of voltage drop. These parameters mostly affect the voltage discharge trajectory in the quasi-linear phase.

For the purpose of EOD prediction, the burden on the system to estimate the parameters with high accuracy can be reduced provided that the system can estimate the discharge capacity with accuracy or with minimum error. In one embodiment of the present application, the hybrid reasoning approach can be based on these observations with reference to the EC model or the physics-based model (PBM) parameters and their contribution to the prediction of EOD or remaining useful life of the target system.

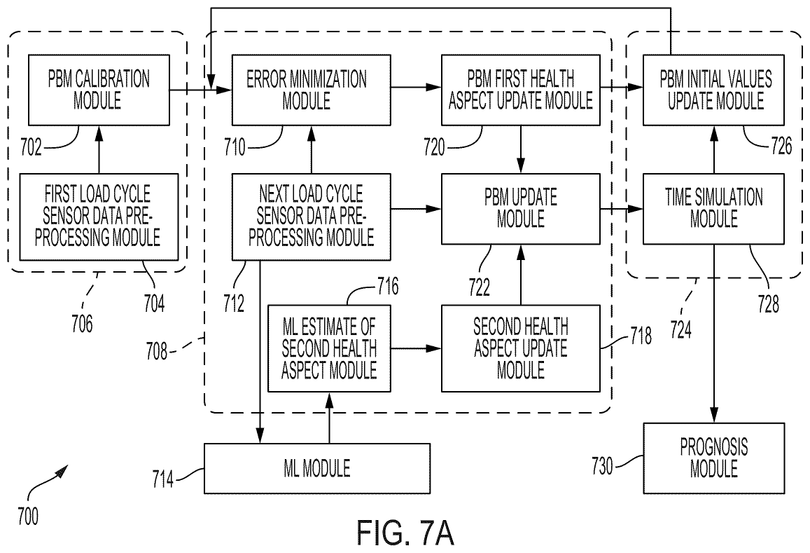

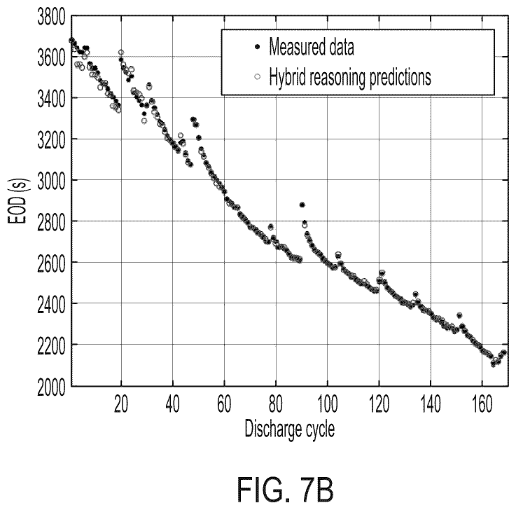

FIG. 7A illustrates an exemplary hybrid reasoning system architecture with mutual coupling between physics-based model and machine learning model, in accordance with one embodiment of the present application. In the example shown in FIG. 7, hybrid reasoning system 700 provides a mutual connection between the physics-based model and machine learning model to generate a prediction about the health of the target system. In other words, system 700 provides a coupling of wear/degradation modes progressing at two different time scales. Based on the wear/degradation progression in both time scales system 700 may perform a prognosis reasoning about the health of the target system. Specifically, system 700 may update physics-based model parameters based on both first mode and second mode of degradations. More specifically, system 700 may perform parameter update based on limited data associated with the first mode of degradation (e.g., voltage discharge when lithium-ion battery is used as the target system) and based on machine learning model predictions on discharge capacity (ageing). In FIG. 7, physics-based modeling is used in blocks 702, 710, 722, and 728, while machine learning is applied in blocks 714 and 716. Blocks 720, 718, and 726 demonstrate an update process of the model parameters and corresponding mathematical process.

While a lithium-ion battery is considered here as an illustrative example system, other types of systems can be considered for performing hybrid reasoning of the system health. A trained machine learning model 714 can predict a discharge capacity of the battery given the voltage discharge data from an initial time period, e.g., the first 500 s of data. System 700 may use the predicted discharge capacity to update a part of the PBM. Also, system 700 may update the rest of the PBM parameters based on minimizing error between the model time simulation outputs and observations (i.e., measured discharge voltage).

Hybrid reasoning system 700 can include a number of different operations which can be grouped into different phases. For example, in a first phase PBM calibration module 702 can calibrate a PBM based on data of the first discharge cycle from a sensor data pre-processing module 704. Specifically, PBM calibration module 702 may use the measured voltage data related to one full discharge trajectory for the first discharge cycle (n=1) to calibrate the PBM. Module 702 may generate a calibrated PBM with a set of initial values for the PBM parameters. System 700 can perform further calibration of the PBM by applying an error minimization module 710 to minimize an error between the PBM time simulation outputs and observations (measured discharge voltage) data over the first discharge cycle. Specifically,

min h(x)=Σᵢ₌₁^{m}(Vₘ(tᵢ)−Vₛ(x,tᵢ))² (11)

where x∈R, t∈[0 t_{c}], and x denotes the PBM parameters' vector and h(x) represents the sum of square of deviations in m data points between simulated voltage data Vₛ(x, tᵢ) and measured voltage data Vₘ(tᵢ). Time, tᵢ, changes in a range with lower band “0” and upper band t_{c}. This time range [0, t_{c}] can show the start and end time of calibration in the first loading cycle (n=1), respectively. Vₛ(x,tᵢ) represents the simulation result and Vₘ(tᵢ) denotes the measured observations. System 700 may apply LMA (shown in FIG. C) to solve this minimization problem in an iterative process to obtain the model parameters for the first discharge cycle according to algorithm shown in FIG. 6B.

In an example second phase, as the target system, e.g., lithium-ion battery, undergoes a next loading cycle (n>1) system 700 may provide information about the first mode and the second mode of degradation to the PBM and accordingly update the PBM parameters (Mₚ). Hence, system 700 can use the voltage discharge data up to the prediction start time (e.g., t=tₚ=500 s) to update the PBM parameters.

In the example second phase, system 700 can apply two different types of updates to update the PBM model. In a first type of update, system 700, error minimization module 710 and PBM first health aspect update module 720 can pre-process measured data up to the prediction start time and can use the pre-processed data for updating the PBM parameters except the discharge capacity (qₘₐₓ) The updated parameters are presented by the first set of parameters of a physics-based model. This update is performed to consider the effects of the first mode of degradation on the first health aspect of the target system. Data pre-processing may include data scrubbing for smoothening the data for noise removal. System 700 may update the PBM by minimizing the deviation between time simulation data and observation data up to a prediction start time. Error minimization module 710 may perform error minimization and find the value of PBM parameters based on equation (7). Through this error minimization, system 700 can solve the state space representation of the physics-based model by algorithm shown in FIG. 6B from time zero to time of prediction (e.g., t=tₚ=500 s)

In the second type of update, system 700 may update the PBM based on operations in ML module 714, ML estimate of second health aspect module 716, and second health aspect update module 718. The second health aspect of the target system can correspond to the second mode of degradation. System 700 may provide the pre-processed voltage discharge data prior to the prediction start time to an already built or trained ML model, i.e., ML module 714. System 700 may then apply module 716 to estimate the discharge capacity (which corresponds to the second set of parameters of physics-based model). The data pre-processing operations can involve data-scrubbing, data transformation, and feature extraction. System 700 may apply second health aspect update module 718 to update a discharge capacity value based on the estimated discharge capacity. Accordingly, module 718 may update physics-based model parameter set (Mₚ). PBM update module 722 may then update the PBM based on the updates received from module 720 and 718. At the end of the second example phase system 700 may update the PBM parameters with the update including both the first mode of degradation and the second mode of degradation.

In a third example phase, in response to PBM update module 722 updating the PBM model parameter set (Mₚ), system may apply time simulation module 728 to perform time simulation of the PBM based on numerical solution of the state space representation of physics-based equations according to algorithm shown in FIG. 6B. Based on such a time simulation, time simulation module 728 may predict a full discharge trajectory. In other words, at the prediction start time module 728 may provide time-voltage simulated data and predict a discharge trajectory.

In a fourth example phase, system 700 may apply a prognosis module 730 to perform prognosis reasoning which can identify an intersection of the predicted voltage discharge trajectory with the end of discharge voltage threshold (e.g., 2.8 V). The difference between predicted end of discharge time and the current time (e.g., time at prediction point tₚ=500 s) may indicate the remaining time before the end of discharge.

Furthermore, system 700 may provide the PBM initial parameters values, by PBM initial values update module 726, to the algorithm (shown in FIG. 6B) so that the updated initial values of parameters may be used as new initial values for the next discharge cycle (n>1). In other words, system 700 may initiate the update of the PBM parameters with a set of parameters obtained from the calibration (in module 702) in the first discharge cycle (n=1). In the next cycles (n>1), system 700 may start with the updated parameters obtained from the previous cycle (n−1), i.e., from PBM initial values update module 726.

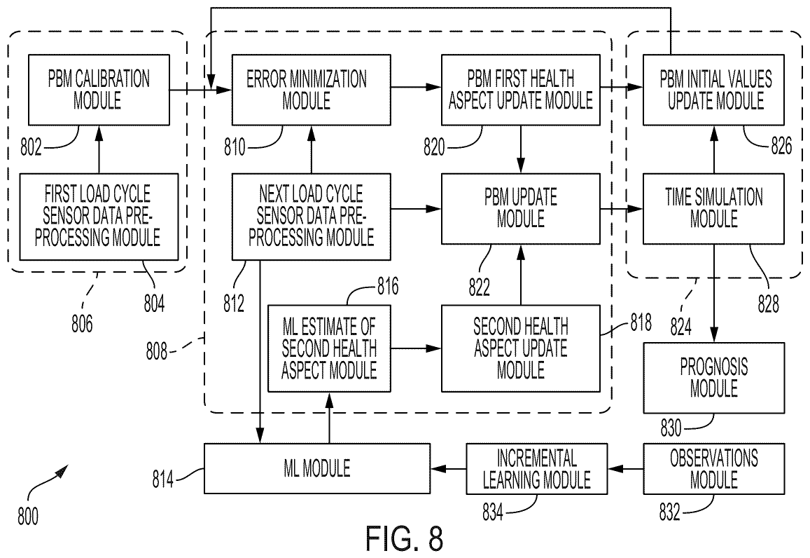

Hybrid reasoning system architecture 700 can start prediction of RUL of the target system early, for the lithium-ion battery case prediction starts at 500 s. System 700 can calibrate the PBM based on one full discharge trajectory. Further, system 700 can develop a predictive ML model based on the measured voltage discharge which can be used to estimate discharge capacity that represents the second mode of degradation for a lithium-ion battery and can hence address the problem of updating the PBM parameters. In addition, due to the early prediction capability of system 700, system 700 can alleviate the dependency on data of the last phase of voltage discharge for predicting the RUL. One embodiment of the application provides an enhanced hybrid reasoning system and method for further improving the data efficiency and for solving the problem of scarce data availability. The enhanced hybrid reasoning system is described below in reference to FIG. 8.

FIG. 7B shows an exemplary end of discharge time prediction for a hybrid reasoning system, in accordance with an embodiment of the present application. In the example plot shown in FIG. 7B, x-axis shows number of discharge cycles and the y-axis represents the end of discharge time for each cycle of voltage discharge loading. Each prediction point can represent an intersection of a predicted voltage discharge trajectory with end of discharge voltage threshold, e.g., 2.8 V. In other words, this figure is a two-dimensional projection of a three-dimensional space where each point summarizes one trajectory. It can be observed that the predictions are in high agreement with measured observations.

The proposed hybrid reasoning is data efficient since it uses voltage discharge data up to a prediction start time, e.g., 500 s, and needs only one full discharge cycle for calibration. Since the entire discharge trajectory is predicted in a parameterized mathematical framework, the results are interpretable, explainable, and robust. In other words, the predictions come from an updated physics-based model that predicts the entire discharge trajectory. Unlike the point-wise prediction of end of discharge/life, prediction of full discharge trajectory based on a physical model that abstracts physics of discharge provides for robustness, interpretability, and explainability of prognosis reasoning.

FIG. 8 illustrates an exemplary hybrid reasoning system architecture with mutual coupling between physics-based model and machine learning model with incremental learning, in accordance with one embodiment of the present application. In the example shown in FIG. 8, hybrid reasoning system 800 is described with reference to lithium-ion battery as the target system, however, system 800 can be applied for predicting remaining useful life of other types of target system with wear/degradation pattern similar to that shown in FIG. 1. To further improve data efficiency of the machine learning model, system 800 can train the machine learning model based on concepts of transfer learning and incremental learning for predicting a second mode of degradation (aging) that can happen due to a capacity fade. Hence, a machine learning model is trained based on concepts of transfer learning and incremental learning. Similar to the previous hybrid approach shown in FIG. 7A, system 800 applies a machine learning model for informing the physics-based model about the second mode of degradation.

The machine learning model follows a similar architecture as described FIG. 6D except for the number of cells in hidden layers. For example, the number of neurons in the hidden layer connected to input layer can be 40 and the number of neurons connected to output layer can be 25. System 800 may train the ML model based on data of the similar type of batteries as the training system is then tested on a different battery (of the same make) in the target domain. The shift is due to different capacity fade patterns.

In the example shown FIG. 8, the function of modules 802-806, 810-812 and modules 816-830 are similar to that of the corresponding modules 702-706, 710-712 and 716-730 in FIG. 7A. Hybrid reasoning system architecture 800 may involve incremental learning of a transferred ML model indicated in ML model module 814. In other words, system 800 may update the pre-set weights of the transferred model based on incremental learning techniques. Specifically, as system 800 receives new observations (measured discharge voltage data) system 800 retrain the ML model using gradient descent with the adaptive learning rate.

For example, observations module 832 in response to observing the predicted discharge trajectory in cycle n for a discharge capacity, may provide these observations to incremental learning module 834 to update the weights of a pre-built or pre-trained ML model 814. In other words, system 800 may retrain ML model 814 based on gradient descent with an adaptive learning rate that updates the weights of network in ML model 814. This means that to predict discharge trajectory of cycle n+1, system 800 may inform ML model 814 about the observations corresponding to a previously predicted discharge trajectory in cycle n.

In other words, system 800 can predict end of discharge time for a lithium-ion battery with improved accuracy and efficiency in data. System 800 (in ML module 814) can train machine learning model based on data of similar batteries as the training system and can then test the machine learning model based on a different battery (e.g., the battery can be of the same make) in the target domain. System 800 may then apply the trained ML model to a target domain (i.e., for the target system under consideration). ML model inputs can be features of voltage profile up to prediction start time, e.g., 500 s, for each voltage signal and can output battery discharge capacity. ML module 814 can perform the model transfer by updating the model weights for the target domain based on the trained model in the training system.

Specifically, ML module 814 can apply the pre-set weights to update the ML model based on the incremental learning techniques, which means that as system 800 receives new observations, ML module 814 can re-train the ML model using gradient descent with an adaptive learning rate. In one embodiment, system 800 can repeat the steps of incrementally estimating the discharge capacity (or indicator of the second health aspect of the target system) and incrementally fine tuning the PBM model. System 800 may, based on the estimated discharge capacity, update a part of the PBM model. System 800 may further update other parameters of the PBM based on minimizing error between the PBM model output and observations (described in reference to FIG. 7).

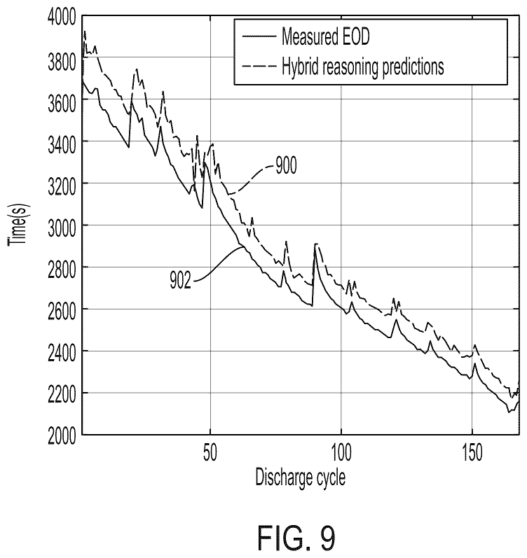

FIG. 9 shows an exemplary end of discharge time prediction for a hybrid reasoning system with incremental learning, in accordance with an embodiment of the present application. In the example plot shown in FIG. 9, x-axis shows number of discharge cycles and the y-axis represents the end of discharge time for each cycle of voltage discharge loading. The curves 900 and 902 are obtained by connecting the prediction and measurement points. Each prediction point can represent an intersection of a predicted voltage discharge trajectory with end of discharge voltage threshold, e.g., 2.8 V. In other words, FIG. 9 is a two-dimensional projection of a three-dimensional space where each point summarizes one trajectory.

It can be observed that for a hybrid reasoning system with incremental learning (shown in FIG. 8) the end of discharge time prediction 900 is in an acceptable tolerance range with the measured data 902. For the example results shown in FIG. 9, the root mean square of the error between the samples of two curves (measured and hybrid reasoning prediction) is approximately 130.74 s. Furthermore, the hybrid reasoning system shown in FIGS. 7A and 8 can predict end-of-discharge time of the target system by using data up to a prediction start time (e.g., 500 s for a lithium-ion battery, but several other time points can be chosen, and prediction can be continued after the start time).

The hybrid reasoning system is data efficient since it uses only voltage discharge data up to a prediction start time far less than the end of discharge time, e.g., 500 s, and needs only one full discharge cycle for calibrating the PBM. Since the entire discharge trajectory is predicted in a parameterized mathematical framework, the results are interpretable, explainable, and robust. In other words, the predictions ultimately come from an updated physics-based model that predicts the entire discharge trajectory. Unlike the point-wise prediction of end of discharge/life, prediction of full discharge trajectory based on a physical model that abstracts physics of discharge provides for robustness, interpretability, and explainability of prognosis reasoning. Further, the system can be data efficient when applied to unseen systems and can predict without using pre-compiled dataset for passive training. Therefore, with such an adaptability of the hybrid reasoning in unseen systems with an additional possibility of incremental learning, it can perform online/semi-online end of discharge prediction.

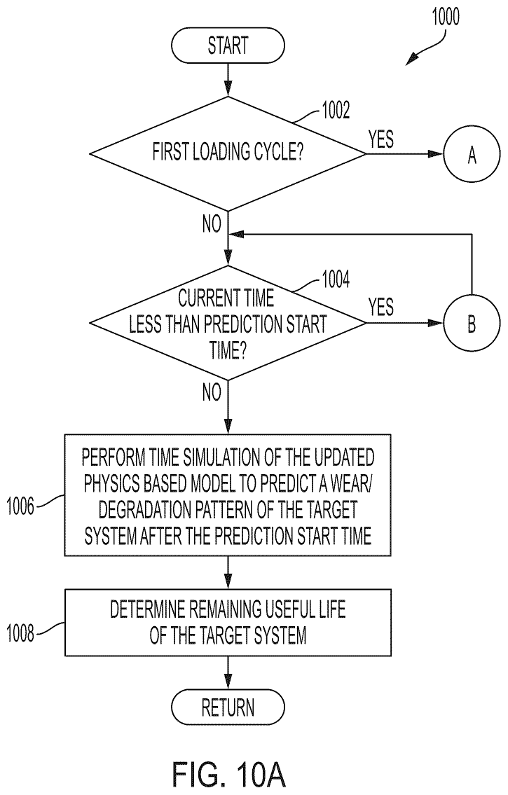

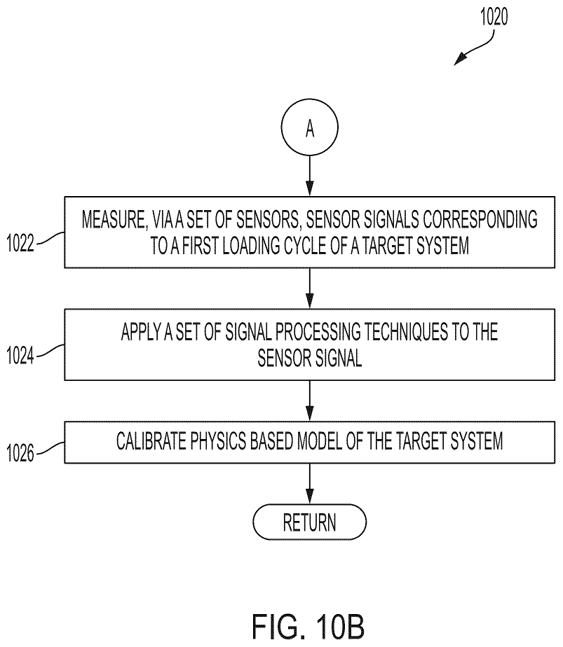

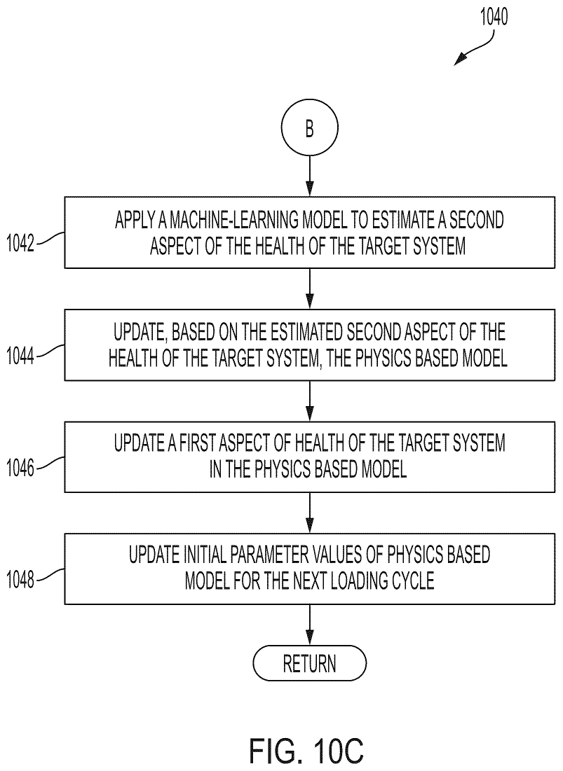

FIGS. 10A-10C present a flowchart illustrating a process for performing hybrid reasoning based on physics and machine learning for prognostics, in accordance with one embodiment of the present application. Lithium-ion battery is used as an example target system for explaining the flowchart in FIGS. 10A-10C. The hybrid reasoning system can be applied to other types of target systems that have a similar wear/degradation pattern shown in FIG. 1. Referring to flowchart 1000 in FIG. 10A, during operation of the hybrid reasoning system, the system may determine whether the target system is in the first cycle of discharge loading (n=1) (operation 1002). When the condition in operation 1002 is satisfied, the system may calibrate the PBM (at label A which is described in reference to FIG. 10B).

When the condition in operation 1002 is not satisfied, i.e., n≠1, the system may determine whether a current time is less that a prediction start time (operation 1004). When the current time is within the range of the start of loading cycle and prediction start time, i.e., 0≤t<tₚ=500 s, the system may update the PBM (at label B which is described in reference to FIG. 10C). When the condition in operation 1004 is not satisfied, i.e., the current time is greater than the prediction start time, the system may predict based on an already updated PBM the voltage discharge trajectory (operation 1006). In other words, in operation 1006 the system may perform time simulation of the updated PBM to predict a wear/degradation pattern of the target system (e.g., the voltage discharge trajectory when the target system is a lithium-ion battery). The system may then perform prognosis reasoning by identifying an intersection of predicted voltage discharge profile with end of discharge voltage threshold (e.g., 2.8 V). In response to identifying this intersection, the system may determine a RUL of the target system (operation 1008).

Flowchart 1020 in FIG. 10B illustrates the operations at label A shown in FIG. 10A. Specifically, in response to determining that the target system is in the first loading, i.e., first discharge cycle loading for lithium-ion battery as the target system (operation 1002 in FIG. 10A), the system may measure, via a set of sensors associated with the target system, sensor signals corresponding to the first cycle of loading of the target system (operation 1022). The system may then apply a set of signal processing techniques to the sensor signals, e.g., to extract certain features from the sensor signals that can be relevant for providing initial parameter values to the PBM (operation 1024). Based on the processed sensor data, the system may calibrate the PBM of the target system (operation 1026).

Flowchart 1040 in FIG. 10C illustrates the operations at label B shown in FIG. 10A. Specifically, in response to determining that current time is within the range of the start of loading cycle and prediction, i.e., 0≤t<tₚ=500 s, (operation 1004 in FIG. 10A), the system may apply a machine learning model to estimate a second aspect of the health of the target system that represents the second mode of degradation (operation 1042). The system may then update the PBM based on both the first mode of degradation and the second mode of degradation (operation 1044 and 1046). The system can then update the initial values of parameters of the PBM for the next loading cycle (operation 1048).

### Exemplary Hybrid Reasoning Computer System

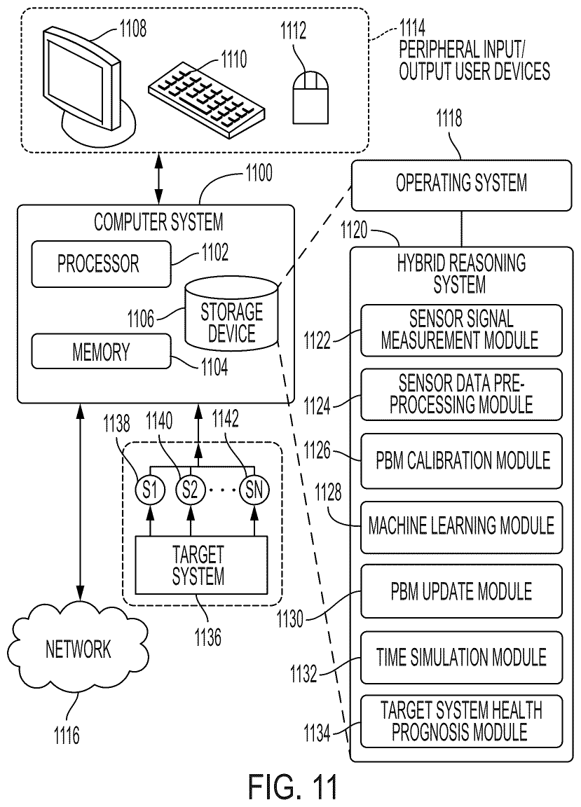

FIG. 11 illustrates an exemplary computer system that facilitates hybrid reasoning based on physics and machine learning for prognostics, in accordance with one embodiment of the present application. Computer system 1100 includes a processor 1102, a memory 1104, and a storage device 1108. Memory 1104 can include a volatile memory (e.g., RAM) that serves as a managed memory, and can be used to store one or more memory pools. Furthermore, computer system 1100 can be coupled to peripheral input/output (I/O) user devices 1114, e.g., a display device 1108, a keyboard 1110, and a pointing device 1112, and can also be coupled via one or more network interfaces to a network 1116. Computer system 1100 can be coupled to a target system 1136 via one or more network interfaces and can also communicate with a set of sensors 1138-1142. Storage device 1106 can store instructions for an operating system 1118 and a hybrid reasoning system 1120.

In one embodiment, hybrid reasoning system 1120 can include instructions, which when executed by processor 1102 can cause computer system 1100 to perform methods and/or processes described in this disclosure. Hybrid reasoning system 1120 can include a sensor signal measurement module 1122 for measuring and recording sensor signals from sensors 1138-1142 that are attached to a target system 1136 whose wear/degradation pattern is to be predicted. Sensor signal measurement module 1122 can measure and record sensor signals of target system 1136, e.g., for lithium-ion battery module 1122 can measure voltage discharge data up to a prediction start time. Hybrid reasoning system 1100 can further include instructions implementing a sensor signal/data pre-processing module 1124 for performing pre-processing on the sensor data before the sensor data is used for predicting the wear/degradation pattern of target system 1136.

Hybrid reasoning system 1120 can include a PBM calibration module 1126, which can calibrate the PBM parameters based on the pre-processed sensor data from a first loading cycle (or discharge cycle for lithium-ion battery). Hybrid reasoning system 1120 can further include instructions for implementing a machine learning module 1128 for estimating a second health aspect of target system 1136 that represents the second mode of degradation of target system 1136, based on sensor data up to the prediction start time. Machine learning module 1128 may provide the estimated second aspect of health of target system to a PBM update module 1130 which can update the corresponding parameters of the PBM accordingly.

Hybrid reasoning system 1120 may measure sensor signals from a loading cycle and can pre-process the measured sensor signals using module 1122 and 1124, respectively. Machine learning module 1128 may further improve the estimate of the second mode of degradation (or second aspect of the health of target system 1136) based on the pre-processed sensor data. Based on the improved estimate, PBM update module 1128 can update the PBM parameters associated with the second mode of degradation. In one embodiment, machine learning module 1128 may apply incremental learning to estimate the second mode of degradation and hence update the corresponding PBM parameters.

Hybrid reasoning system 1120 can further perform error minimization between the PBM time simulation outputs and a set of observations in the current loading cycle. Based on this error minimization operation PBM parameters associated with the first mode of degradation of target system 1136 or the first aspect of health of target system 1136 is updated. PBM update module 1128 can apply the parameter updates associated with the first mode of degradation and parameter updates associated with the second mode of degradation to fully update the PBM.

Hybrid reasoning system 1120 can further include instructions to implement a time simulation module 1132 for simulating a wear/degradation pattern for target system 1136, e.g., in the case of lithium-ion battery module 1132 may predict a voltage discharge trajectory. Target system health prognosis module 1134 may use the predicted wear/degradation pattern to determine a RUL about target system 1136, e.g., in the case of lithium-ion battery module 1134 may predict the end-of-discharge time.

Therefore, hybrid reasoning system 1120 can integrate physics-based modeling techniques with data-based approaches in an optimized manner to provide a data efficient solution to prognostics problem. Hybrid reasoning system 1120 can provide a generic abstraction of the prognostics problem that can be generalized to other systems with similar degradation/wear patterns. Furthermore, with the optimized combination of the physics-based technique and the data-based approaches, results of hybrid-reasoning system 1120 can be interpretable and explainable, which can address the user's concern regarding pure-data based approached due to their “black-box” nature.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules or apparatus. The hardware modules or apparatus can include, but are not limited to, application-specific integrated circuit (ASIC) chips, field-programmable gate arrays (FPGAs), dedicated or shared processors that execute a particular software module or a piece of code at a particular time, and other programmable-logic devices now known or later developed. When the hardware modules or apparatus are activated, they perform the methods and processes included within them.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computer-implemented method for predicting health of a target system, comprising:
during operation of the target system, measuring, via a set of sensors associated with the target system, sensor signals corresponding to a first loading cycle of the target system before a prediction start time;
updating, based on the measured sensor signals, a first set of parameters of a physics-based model associated with the target system, wherein the first set of parameters represents a first aspect of health of the target system;
in response to determining that the target system is subject to a next cycle of loading and the current time is less than a prediction start time:
applying a machine-learning model to estimate a second aspect of the health of the target system; and
updating, based on the estimated second aspect of the health of the target system, a second set of parameters of the physics-based model;
performing a time simulation of the updated physics-based model to predict a wear/degradation pattern of the target system corresponding to after the prediction start time; and
determining, based on the predicted wear/degradation pattern, a remaining useful life of the target system.

2. The computer-implemented method of claim 1, wherein the first aspect of the health of the target system represents a first mode of degradation on a first timescale;
wherein the second aspect of the health of the target system represents a second mode of degradation on a second timescale;
wherein the first timescale is different from the second time scale; and
wherein degradation includes one or more additional degradation modes.

3. The computer-implemented method of claim 1, wherein the prediction starts after an initial period of operation of the target system.

4. The computer-implemented method of claim 1, wherein an intersection of the predicted wear/degradation pattern and an end-of-life threshold represents a predicted end-of-life of the target system; and
wherein the remaining useful life of the target system corresponds to the difference between a current time of the target system and the predicted end-of-life of the target system.

5. The computer-implemented method of claim 1, further comprising:
training the machine learning model with data from a training system to generate a set of machine learning model parameters, wherein the training system includes one or more systems with respective wear/degradation pattern similar to wear/degradation pattern of the target system;
incrementally updating, based on the measured sensor signals, the set of machine learning model parameters; and
incrementally estimating, based on the updated set of machine learning model parameters, the second aspect of the health of the target system.

6. The computer-implemented method of claim 1, wherein the target system corresponds to a system that undergoes a degradation and/or wear with time, wherein the target system includes one or more of:
a battery;
power storage devices;
rotating machines;
chemical plants;
automotive components;
biomedical components;
aerospace components;
nuclear power components;
maritime components;
mining components;
medical equipment components;
manufacturing systems components
civil engineering related systems; and
electrical engineering related systems.

7. The computer-implemented method of claim 1, further comprising: applying a set of signal processing techniques to the measured sensor signals to obtain a set of features for developing the machine learning model and updating the physics-based model.

8. The computer-implemented method of claim 7, wherein the signal processing techniques include one or more of:
data scrubbing;
feature extraction; and
data transformation.

9. The computer-implemented method of claim 1, further comprising:
in response to determining that the target system is subject to the first loading cycle, calibrating, based on the measured sensor signals, the parameters of a physics-based model associated with the target system.

10. The computer-implemented method of claim 1, further comprising:
performing error minimization between output of the time simulation physics-based model and measured sensor signals during the next loading cycle of the target system;
generating, based on the error minimization, a new first set of parameters; and
updating, based on the new first set of parameters, the physics-based model.

11. A computer system, comprising:
a processor;
a storage device storing instructions that when executed by the processor cause the processor to perform a method for predicting health of a target system, the method comprising:
during operation of the target system, measuring, via a set of sensors associated with the target system, sensor signals corresponding to a first loading cycle of the target system before a prediction start time;
updating, based on the measured sensor signals, a first set of parameters of a physics-based model associated with the target system, wherein the first set of parameters represents a first aspect of health of the target system;
in response to determining that the target system is subject to a next cycle of loading and the current time is less than a prediction start time:
applying a machine-learning model to estimate a second aspect of the health of the target system; and
updating, based on the estimated second aspect of the health of the target system, a second set of parameters of the physics-based model;
performing a time simulation of the updated physics-based model to predict a wear/degradation pattern of the target system corresponding to after the prediction start time; and
determining, based on the predicted wear/degradation pattern, a remaining useful life of the target system.

12. The computer system of claim 11, wherein the first aspect of the health of the target system represents a first mode of degradation on a first timescale;
wherein the second aspect of the health of the target system represents a second mode of degradation on a second timescale;
wherein the first timescale is different from the second time scale; and
wherein degradation includes one or more additional degradation modes.

13. The computer system of claim 11, wherein the prediction starts after an initial period of operation of the target system.

14. The computer system of claim 11, wherein an intersection of the predicted wear/degradation pattern and an end-of-life threshold represents a predicted end-of-life of the target system; and
wherein the remaining useful life of the target system corresponds to the difference between a current time of the target system and the predicted end-of-life of the target system.

15. The computer system of claim 11, further comprising:
training the machine learning model with data from a training system to generate a set of machine learning model parameters, wherein the training system includes one or more systems with respective wear/degradation pattern similar to wear/degradation pattern of the target system;
incrementally updating, based on the measured sensor signals, the set of machine learning model parameters; and
incrementally estimating, based on the updated set of machine learning model parameters, the second aspect of the health of the target system.

16. The computer system of claim 11, wherein the target system corresponds to a system that undergoes a degradation and/or wear with time, wherein the target system includes one or more of:
a battery;
power storage devices;
rotating machines;
chemical plants;
automotive components;
biomedical components;
aerospace components;
nuclear power components;
maritime components;
mining components;
medical equipment components;
manufacturing systems components
civil engineering related systems; and
electrical engineering related systems.

17. The computer system of claim 11, wherein the method further comprising: applying a set of signal processing techniques to the measured sensor signals to obtain a set of features for developing the machine learning model and updating the physics-based model.

18. The computer system of claim 17, wherein the signal processing techniques include one or more of:
data scrubbing;
feature extraction; and
data transformation.

19. The computer system of claim 11, wherein the method further comprising:
in response to determining that the target system is subject to the first loading cycle, calibrating, based on the measured sensor signals, the parameters of a physics-based model associated with the target system.

20. The computer system of claim 11, wherein the method further comprising:
performing error minimization between output of the time simulation of physics-based model and measured sensor signals during the next loading cycle of the target system;
generating, based on the error minimization, a new first set of parameters; and
updating, based on the new first set of parameters, the physics-based model.
